(19) United States
(12) Patent Application Publication
(10) Pub. No.: US 2017/0336347 A1
(43) Pub. Date: Nov. 23, 2017

(54) SiNW PIXELS BASED INVERTING AMPLIFIER

(71) Applicant: RG SMART PTE. LTD., Singapore (SG)

(72) Inventors: Ayal RAM, Singapore (SG); Amir LICHTENSTEIN, Singapore (SG)

(21) Appl. No.: 15/157,265

(22) Filed: May 17, 2016

(51) Int. Cl. G01N 27/414

(52) U.S. Cl. CPC G01N 27/4145

(57) ABSTRACT

In some embodiments, an inverting amplifier includes four electrical circuit elements (or “pixels”), with two pixels used as sensing elements and two pixels used as adjustable resistors for adjusting amplification factor to operate all pixels at the same amplification factor and cancelling out variations from processing. The sensing pixels include a silicon nanowire exposed to liquid or gas medium for sensing, a metal electrode partially open for contact with the medium and used for feeding a high-frequency sinusoidal stimulation in impedance measurements and for sensing properties of the medium, implanted source and drain electrodes connected to the nanowire, and electrical metal contacts attached to the electrodes and connecting the pixel to an electrical circuit. The two compensation pixels include an n-type or p-type silicon nanowire, implanted source and drain electrodes connected to the nanowire, and electrical metal contacts attached to the electrodes and connecting the pixel to an electrical circuit.

### TECHNICAL FIELD

In general, the present application relates to the field of nanoelectronics. In particular, the present application relates to the nanoelectronic sensors based on silicon nanowires which are configured in an adjustable, inverting amplifier bridge.

### BACKGROUND

Nanomaterials possess unique physical properties due to their confinement down to the nanometre scale in at least one dimension. Combination of nanomaterials and biological processes opens up new horizons for modern biotechnological applications, particularly for biosensing. Not only nanomaterials enable miniaturisation of devices, but also ensure their high sensitivity due to the significantly increased surface-to-volume ratio.

As nanomaterials in general, nanowires and their arrays in particular, confined down to the nanometre thickness, show many advantages over conventional wires, such as significantly increased signal-to-noise ratio, increased charge carrier transport and low detection limit. Therefore, the nanowires are now considered a new class of ultrasensitive electrochemical tools and electrochemical sensors.

However, since these sensor devices operate in ultralow current regimes and are in general very sensitive to various influences from side parameters, which generally decreases the stability and reliability of the sensor operation, special designs and array layouts are advised, which enable maximum control of the sensors performance. This includes a gate voltage control from front side via a stable electrochemical reference electrode system and from back side via a back gate contact. In addition, a shift to the frequency domain for alternative sensor readout stabilisation aids more reliable performance in biosensor applications.

Silicon nanomaterials are a type of nanomaterials with attractive properties, including excellent semiconducting, mechanical, optical properties, favourable biocompatibility, surface tailorability, and relatively compatible with conventional silicon technology. A silicon nanowire (hereinbelow, “SiNW”) is defined as a “one-dimensional” silicon nanostructure exhibiting a length-to-diameter aspect ratio of 1000 or more. The diameter of a regular SiNW is in order of single-digit nanometres. At this scale, quantum mechanical laws become totally dominant, and SiNWs have many interesting properties that are not seen in larger objects and three-dimensional materials. Since quantum confinement of electrons in SiNWs to one dimension is predicted to be substantial only at diameters below 3 nm, the band structure is strongly modified for these nanowires having diameters of single-digit nanometres. The band gap in SiNWs increases for smaller diameters and a direct band gap can be obtained for sufficiently small diameters. Silicon nanowires have been extensively explored for myriad applications ranging from electronics to biology (Zhang et al 2008).

A field-effect transistor (FET) is a semiconductor based device with relatively low power consumption used for switching or signal amplification in electrical circuits. Widely used transistors are metal oxide semiconductor field-effect transistors (MOSFETs) having two highly doped domains (n- or p-type) separated by a p- or n-type domains, respectively, with p-n or n-p junctions at the interface enabling a tunnelling operation. Common elements for doping of silicon are boron (p-type) or arsenic/phosphoric (n-type).

The doped domains are connected to source (S) and drain (D) ohmic contacts. A metal gate is placed on top of the area between the S and D contacts, separated by a thin insulating oxide layer. Conductance of the transistor is controlled by an external field, for instance the gate field. By applying a positive or negative gate voltage at the gate, electrons are either attracted or repulsed at the semiconductor-oxide interface. Once the threshold voltage is reached, an inversion layer forms a conducting channel between the n- or p-type regions connected to the S and D contacts. Size of the formed channel depends on both, the external gate field and the selection of the materials. Applying an additional SD bias voltage enhances the charge carrier movement through the channel and narrows the channel at one certain end. Thus, conductance of the charge carriers is altered, and electrons become attracted by the drain.

Ion-sensitive FETs (ISFETs) are similar to the common MOSFET, but the metal gate electrode is replaced with an electrolyte solution carrying analyte molecules and containing a reference electrode. The electrolyte solution is defined as a “liquid gate”, which controls the current between the S and D contacts. The liquid gate electrode is separated from the channel by an ionic “double layer” barrier which is sensitive, for example to protons, and therefore, suitable for pH measurements. In general, reactions of charged analytes with corresponding ligand groups at the ISFET sensor surface cause a surface charge, which leads to an additional surface potential. This change in surface potential is monitored and can be related to the number of adsorbed analyte molecules. Using different surfaces and surface functionalisation techniques, sensitivity to specific target analyte molecules can be achieved with this sensor. For sensing, it is important to include a reference electrode to control the solution potential and to apply the liquid gate voltage.

Conductance in ISFETs is strongly dependent on the charge density at the oxide-electrolyte interface. ISFETs are sensitive towards any electrical fields in general, and to charged molecules in particular. Depending on the point of zero charge of the surface and the pH of the electrolyte a respective surface charge is building up, the charging of the terminal surface groups behaves like a local gate potential. Therefore, it is possible to detect variations in the pH of the solution, i.e. taking or giving away protons at the functional interface is sensed. For the transfer characteristics of the devices, the drain source current (I_{DS}) is measured as a function of the applied gate voltage V_{G}. In a semi-logarithmic scale, the steepest slope of the curve I_{DS} vs V_{G} is defined as a sub-threshold swing with the threshold voltage V_{T} at which the current is switched on due to the formation of an inversion layer at the insulator-semiconductor interface. At this point the FET switching can happen at maximum speed. By analysing this slope, which is constant over several orders of magnitude, curve shifts at a fixed current due to attached charged molecules can be determined (ΔV_{T}).

Because of the possible (de)protonation of the surface oxide, pH measurements are usually applied to probe the device performances for potential application in biosensing. By changing pH, the surface potential is directly affected and influences the V_{T}. As a result, the curve of I_{DS} vs V_{G} shifts to lower or higher voltage values. Sensitivity of ISFETs is thus determined by the maximum possible shift because of a pH change, and defined by the Nernst limit of 59.2 mV/pH at 300 K, as explained in detail by Tarasov in his PhD thesis “Silicon Nanowire Field-effect Transistors for Sensing Applications” (2012).

As most biomolecules display charges at their outer surface, ISFETs are equally sensitive to biomolecules such as proteins or DNA. Thus, their I_{DS} vs V_{G} curve shifts parallel to the V_{G} X-axis when the charge density changes. This can be further analysed the same way as for the aforementioned pH measurements.

Bavli et al (2012) showed a two-dimensional (planar) FET (used as a molecularly controlled semiconductor resistor), run in liquid environment, for the detection of different analytes on a lipid bilayer functionalized surface with a detection limit in the μg/ml range, which clearly indicates that this FET lacks low detection limits. Hammock et al (2013) introduced a planar organic FET for thrombin sensing using an aptamer. The signal of this sensor was enhanced by adsorption of randomly distributed gold nanoparticles and achieved a detection limit of 100 pM.

SiNWs can be used similar to FETs to build sensor devices with strong signal amplification at low power consumption which is advantageous for portable or implantable devices. One-dimensional FETs strongly benefit from an extreme surface-to-volume ratio, which allows effective channel gating from even just a few adsorbed analyte molecules. SiNW based FET sensing was described first by Cui et al in 2001 using vapour-liquid-solid (VLS) grown silicon nanowires (Si-NWs) for pH sensing and detecting the binding of streptavidin protein on biotin-labelled wires. To date they demonstrated sensing of DNA/PNA hybridisation (Hahm and Lieber 2004), viruses down to single virus detection events (Patolsky et al 2004), using antibodies as receptors, multiplexed sensing (Patolsky et al 2006) and cell potentials (Jiang et al 2012).

SiNW based FETs used for biosensing belong to the group of ISFETs and therefore operate in liquid medium. SiNWs offer to ISFETs high surface-to-volume ratios for good sensitivity and small cross-sectional conduction pathways. Thus, they can overcome the detection limits of planar ISFETs. SiNW based FETs have a conductance of 4-10 times higher than planar standard ISFETs of the same sizes due to their high surface-to-volume ratio and the efficient penetration of the gate field.

In biosensing applications of SiNW FETs, as in ISFETs, liquid also acts as a gate electrode and variations in the surface potential are converted to a conductance change in the channel. Actually, different from planar ISFETs, the one-dimensional SiNWs themselves are conduction channels, which are fully affected by surface potential. Biological recognition events strongly alter the surface potential of the SiNWs even at low analyte concentrations. Charged biomolecules can locally act as liquid gate leading to resistivity changes, which (resistivity) is very sensitive to the biorecognition event. Due to signal amplification by the FET, the signal can be detected by significant jumps in the voltage at a fixed source drain current. Commonly, single-crystalline nanowires are with p- or n-type doping to create charge carriers that are attracted or repelled by the attaching charged biomolecules.

SiNWs can be combined with existing processing technology for silicon wafers to fabricate chips which reduces the cost of disposable chips. Many groups developed SiNW arrays in top-down fabrication to measure biorecognition events like protein detection using antibodies (Elnathan et al 2012) or hybridisation (Zhang et al 2008). In order to use these devices as biosensors, silicon dioxide (SiO₂) surface of SiNWs should be functionalised with biorecognition elements.

For all the different applications, interface engineering and chemical functionalisation of the transducer (SiO₂) surface are crucial for biosensor development to assure an excellent sensor performance. Requirements are a stable receptor attachment under varying conditions, while preserving the functionality of receptors at the same time. Additionally, binding strategies will enhance the receptor orientation towards the target in solution whereas blocking protocols try to avoid unspecific attachment to reduce background signals. The main focus here is on chemical functionalisation of silicon dioxide surfaces of SiNWs and evaluation of the receptor-analyte interactions with the immobilised receptors using optical and electrical sensing methods with SiNWs.

Real-time, label-free, portable, low-cost, flexible and reliable sensors with lab on chip systems are long-needed biomedical diagnostic devices, and they are still challenging. Further requirements to evaluate novel biosensors are their sensitivity to detect low levels of the analyte, selectivity to avoid false positive signals and a fast response time that allows for rapid diagnosis. In terms of fabrication, the integration into existing technologies and production, the versatility of application and the possibility to produce at low costs are crucial. Reversibility of the biosensor would allow for repeated measurements to improve comparability.

Integration of nanomaterials into biosensor's transducer is one of the possibilities to meet some of the above listed requirements especially in terms of miniaturisation and sensitivity due to their high surface-to-volume ratio and the confinement within the nanometre scale in at least one dimension, which leads to changes in the physical properties. SiNW based FETs fulfill many of these requirements. The use of nanomaterials and the possible integration into Si wafer processing technology enables miniaturisation of devices at low costs. The immediate current jump upon physicochemical changes without need for analyte labelling meet the requirements for the modern biosensor of being real-time and label-free.

To improve stability of the existing sensor arrays and ensure reproducibility of the readout, the sensors of some of the disclosed embodiments are fabricated in a parallel batch process on wafers. To enable a control in bioassays, reference sensor structures such as temperature sensors, pH sensors and ionic strength sensors are added to the sensor chip. As discussed below, the design of the pixel array in a three-electrode configuration including a reference electrode and a counter electrode enables an additional operation of the nanoelectronic sensor pixel in the frequency domain. Therefore, the sensors of some of the disclosed embodiments can also be used for impedance spectroscopy applications. A combination of potentiometric and impedimetric readout enables a more reliable sensing of biomolecules with the potential to sense beyond the Debye screening of electrical charges in an electrolyte solution, which is usually the limiting factor in SiNW sensors having only potentiometric or conductometric readout.

Various embodiments may allow various benefits, and may be used in conjunction with various applications. The details of one or more embodiments are set forth in the accompanying figures and the description below. Other features, objects and advantages of the described techniques will be apparent from the description and drawings and from the claims.

### SUMMARY

In one embodiment, the present application provides an inverting amplifier comprising four electrical circuit elements, defined as “pixels”, wherein:

Two pixels used as sensing elements, each comprising:
a silicon nanowire exposed to liquid or gas medium for sensing; wherein said silicon nanowire of one pixel is of n-type and of another pixel is of p-type;
a metal electrode partially open for contact with said medium and used for feeding a high-frequency sinusoidal stimulation in impedance measurements and for sensing properties of said medium;
implanted source and drain electrodes connected to said silicon nanowire, leaving a gate area and parts of said metal electrode open for contact with said medium; and
electrical metal contacts attached to said implanted source and drain electrodes and connecting said pixel to an electrical circuit; and
   Other two pixels used as adjustable resistors for adjusting amplification factor to operate all the pixels of said inverting amplifier at the same amplification factor, and cancelling out variations from processing, each comprising:
an n-type or p-type silicon nanowire directly contacted with a metal electrode placed on top of said silicon nanowire;
said metal electrode coated with a passivation layer providing isolation from said medium;
implanted source and drain electrodes connected to said silicon nanowire, and
electrical metal contacts attached to said implanted source and drain electrodes and connecting said pixel to an electrical circuit.

The inverting amplifier of the disclosure may further comprise a reference electrode.

### BRIEF DESCRIPTION OF THE DRAWINGS

Disclosed embodiments will be understood and appreciated more fully from the following detailed description taken in conjunction with the appended figures.

FIG. 1 schematically shows a single sensing pixel of an embodiment.

FIG. 2 schematically shows the cross-section of a single sensing pixel testing a liquid sample, which contains analyte molecules.

FIG. 3(a) schematically shows a sensing pixel with an open gate area exposed to tested medium.

FIG. 3(b) schematically shows a compensating pixel.

FIG. 3(c) schematically shows a sensing pixel having the gate area partially coated with a metal layer contacting the silicon nanowire, but not the metal electrode.

FIG. 4(a) shows the SEM image of a single sensing pixel of an embodiment.

FIG. 4(b) schematically shows the same single sensing pixel from FIG. 4(a).

FIG. 4(c) schematically shows a SiNW of a pixel and its dimensions.

FIG. 5(a) shows an inverting amplifier configuration given by combination of an n-type and p-type SiNW transistors.

FIG. 5(b) shows the behavior of the inverting amplifier of FIG. 5(a) when all the voltages are applied.

FIG. 6 shows the inverting amplifier of FIG. 5(a) in a bridge configuration with a second arm added, comprising two compensating resistors R₁ and R₂ with a high value of resistance.

FIG. 7(a) shows the inverting amplifier of FIG. 6 with a voltage divider used to shortcut two contacts to one voltage Vₒᵤₜ, which is measured against Vᵢₙ⁻.

FIG. 7(b) shows the behavior of the inverting amplifier of FIG. 7(a) when all the voltages are applied.

FIG. 8(a) shows a vertical mask design of the inverting amplifier of an embodiment.

FIG. 8(b) shows a horizontal mask design of the inverting amplifier of an embodiment.

FIG. 9 shows the inverting amplifier of an embodiment with an adjustable gain.

FIG. 10 shows an IA transfer curve recorded with the inverting amplifier of an embodiment.

FIG. 11 shows the forward and backward scan with the inverting amplifier of an embodiment.

FIG. 12 shows a voltage drift measured over time with the inverting amplifier of an embodiment.

FIG. 13 shows the IA transfer curve for the inverting amplifier of an embodiment without the voltage divider and with the voltage divider at different total resistance values.

FIG. 14 shows the IA transfer curve for the total resistance forward scan of the inverting amplifier of an embodiment at different total resistance values.

### DETAILED DESCRIPTION

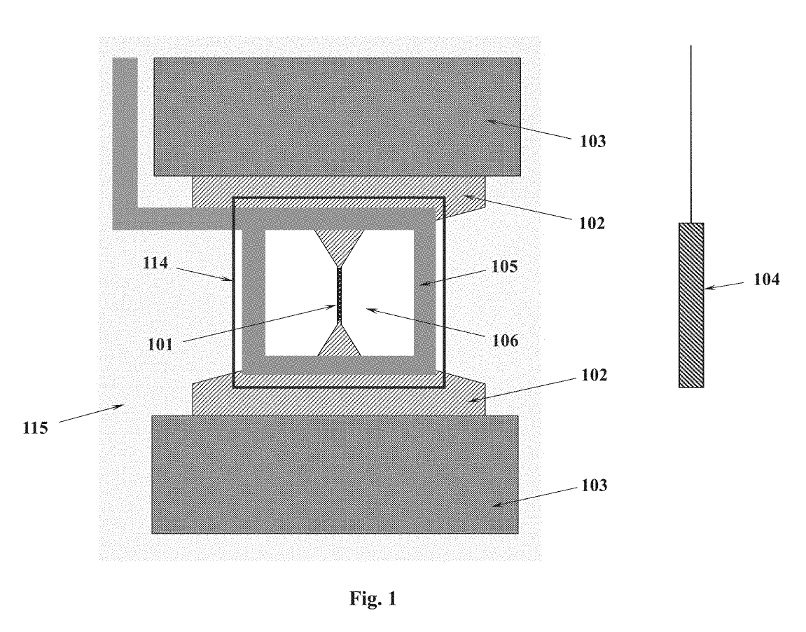

In some embodiments, the present application provides a sensor based on an inverting amplifier comprising four electrical circuit elements, defined as “pixels”. Two of the four pixels of the inverting amplifier are used as sensing elements and therefore, defined as “sensing pixels”. The sensing pixel is schematically shown in FIG. 1 and comprises:
a silicon nanowire (101) exposed to liquid or gas medium for sensing;
a metal electrode (105) partially open for contact with said medium and used for feeding a high-frequency sinusoidal stimulation in impedance measurements and for sensing properties of said medium;
implanted source and drain electrodes (102) connected to said silicon nanowire (101), leaving a gate area (106) and parts of said metal electrode (105) open for contact with said medium; and
electrical metal contacts (103) attached to said implanted source and drain electrodes (102) and connecting said pixel to an electrical circuit.

As will be discussed below, one of the two sensing pixels of the inverting amplifier contains a p-type SiNW, while the other one contains an n-type SiNW. Other two pixels of the inverting amplifier are used as adjustable resistors for adjusting amplification factor in order to operate all the pixels of said inverting amplifier at the same amplification factor, and cancelling out variations from processing. These two pixels are defined as “compensating resistor pixels” or “compensating pixels” and comprise:
an n-type or p-type silicon nanowire directly contacted with a metal electrode placed on top of said silicon nanowire;
said metal electrode coated with a passivation layer providing isolation from said medium;
implanted source and drain electrodes connected to said silicon nanowire, and
electrical metal contacts attached to said implanted source and drain electrodes and connecting said pixel to an electrical circuit.

### Pixels and Their Operation Modes

In a particular embodiment, the silicon nanowires (101) are low-doped, obtained by the silicon-on-insulator (SOI) technology, which allows high carrier mobility, thereby improving performance. The silicon nanowires (101) of the disclosure are produced in a top-down fabrication process. In general, there are two main methods to fabricate single-crystalline silicon nanowires: bottom-up and top-down growth of the nanowire. In the bottom-up approach, single-crystalline SiNWs are grown with vapour-liquid-solid growth method (VLS) which was first described few decades ago by Wagner and Ellis (1964). The bottom-up approach is technologically much easier, but a scale up for industrial fabrication and mass production is not feasible. Although the bottom-up method produces very thin and sensitive wires in the range of only 10 nm, it has a low reproducibility. In fact, bottom-up approach has thus far prevented the commercialisation of such nanowire sensors mainly due its incompatibility with reproducible, high-volume manufacturing. In contrast, various top-down methods entail a high level of non-standard processing complexity and high process variation.

The SiNW of the pixels of disclosed embodiments are therefore fabricated using a top-down method, which has the advantage of producing more robust transistors. In addition, this approach addresses the problems of placement, integration, and reproducibility encountered with bottom-up materials. The modified top-down method, which was developed by the present inventors and described in Vu et al (2009 and 2010), combines wafer-scale nanoimprint lithography techniques defining nanowires from thin single crystalline silicon layers, reactive ion etching and further etching with tetra methyl ammonium hydroxide. After nanowire array fabrication, source and drain are doped by ion implantation to form electrode contacts, gate oxide is grown to create the gate dielectric layer, metal contacts are defined, and finally everything except the wire regions is passivated for sensor use in liquids.

The advantages of the top-down devices compared to those implementing bottom-up grown nanowires are the precise definition of the nanowire arrays on certain areas and the predetermined number of the nanowires on one device, which significantly increases the reproducibility.

The source and drain electrodes (102) are highly doped, in order to reduce feed line resistance, and obtained by the same SOI technology in the same process. The contact leads material is highly-doped silicon, a highly-doped polysilicon layer, a metal layer or preferably, a silicide, such as CoSi, PtSi or TiSi.

In a specific embodiment, the metal electrode (105) is a noble metal electrode, such as platinum counter electrode, which can also be used as a temperature sensor. In a further specific embodiment, the metal electrode (105) may be used as a counter electrode and temperature sensor simultaneously. In yet further embodiment, the metal electrode (105) may be used for the high-frequency AC sinusoidal stimulation in the impedance measurements of the sensor. The metal electrode (105) is chosen according to an established technology and an assembly line at a particular clean room facility.

As shown in FIG. 1, there is a small opening (114), which is made in the passivation layer (115) of the sensing pixel, for leaving the sensing elements of the sensing pixel open to the medium. In addition, the pixel may further comprise a reference electrode (104) open for contact with said medium for creating a three-electrode-cell system and providing a constant potential in the circuit. In a particular embodiment, the reference electrode (104) is an Ag/AgCl reference-cell electrode.

The electrical metal contacts (103) contacting the silicon source and drain connect the pixels to the electrical circuit and allow the electric current to flow in the system. One layer of these contacts is made of aluminium or silicide, such as CoSi, PtSi or TiSi, in order to form a surface alloy with the silicon, thereby providing an electrical ohmic contact to the silicon. The term “ohmic” contact means that it has a straight line in the current-voltage characteristics. These ohmic metal contacts (103) are made of metal or metal stacks, such as Al, Al/Ti/Au or similar. Another layer of these contacts is not contacting silicon and used to promote adhesion to the underlying layers of SiO₂ and Si₃N₄, which are used for isolation. Cr and Ti are examples of such adhesion promoters. The Cr or Ti layers of the metal stack is, for example, of 5-10 nm thickness, while the second metal layer, such as Au, Pt and Cu, is of 100-400 nm thickness. In order to limit the capacitive coupling of the source and drain contact leads and to avoid leakage current into the signal of the sensor, the source and drain contact leads are further covered by a thick layer of insulators.

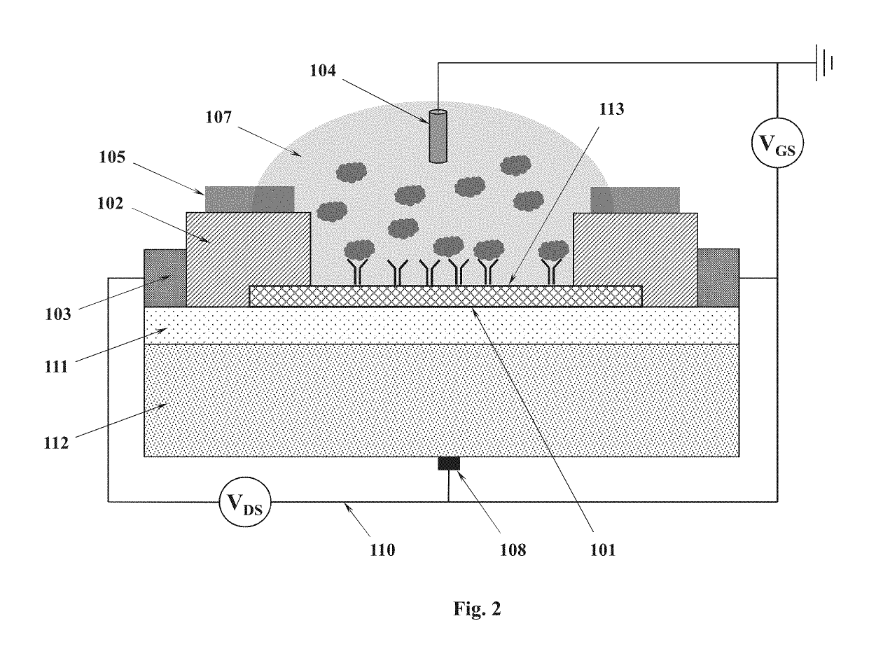

FIG. 2 shows the cross-section of a single sensing pixel, which tests liquid sample (107) containing analyte molecules. The pixel is connected to the circuit (110). As noted above, the pixel is manufactured using the modified top-down approach from SOI wafer handle substrates (112) of about 40-60 nm in thickness of the top silicon layer and a silicon buried oxide (BOX) (111) of approximately 100-400 nm thickness, which acts as an insulator layer. At room temperature and under the assumption that no fixed oxide charges exist, the SiNW (101) is fully depleted of charge carriers in thermal equilibrium. The pixel may further comprise a back gate (108) at the bottom of the handle wafer substrate (112). The back gate is used for tuning the threshold voltage, since the body of the pixel influences that voltage.

The open gate formed by liquid or gas medium (107) effectively controls the charge flow in the SiNW channel. In the gate area (106) (from FIG. 1), the SiNW (101) is coated with a gate oxide (113), which is placed in between the source and drain electrodes (102), and acts as a channel to allow the flow of charge carriers from one electrode to another. This is particularly useful for DC sensing. The gate oxide, also called the gate capacitor or dielectric (113), is a thin layer of oxide or nitride dielectric material, such as SiO₂, Al₂O₃, TaO₂, HfO₂, TiO₂, ZrO₂, TiN, Si₃N₄ or similar. It is grown on top of the silicon substrate between source and drain, protecting the surface of the SiNW from an electrolyte solution, acting as a capacitor for the field effect and providing good pH sensitivity. In case of TaO₂ or Al₂O₃, it is an ideal pH sensor.

In case of SiO₂, the gate oxide (113) has a preferable thickness of 6-8 nm and isolates the SiNW from an electrolyte. The BOX layer (111) of approximately 100-400 nm thickness separates the SiNW from the handle wafer substrate (112) of about 500 μm thickness. Hence, the concentration of charge carriers in the nanowire can be controlled by an electric potential that can either be applied from the top through the thin oxide layer (113) or from the bottom through the thick BOX layer (111). The first gate is called “front gate” (FG), while the second is called “back gate” (BG). Like in any SOI fully-depleted device with a very thin top silicon layer, both gates are strongly coupled electrostatically. This indicates that the back-gate potential affects the front-gate characteristics and vice versa.

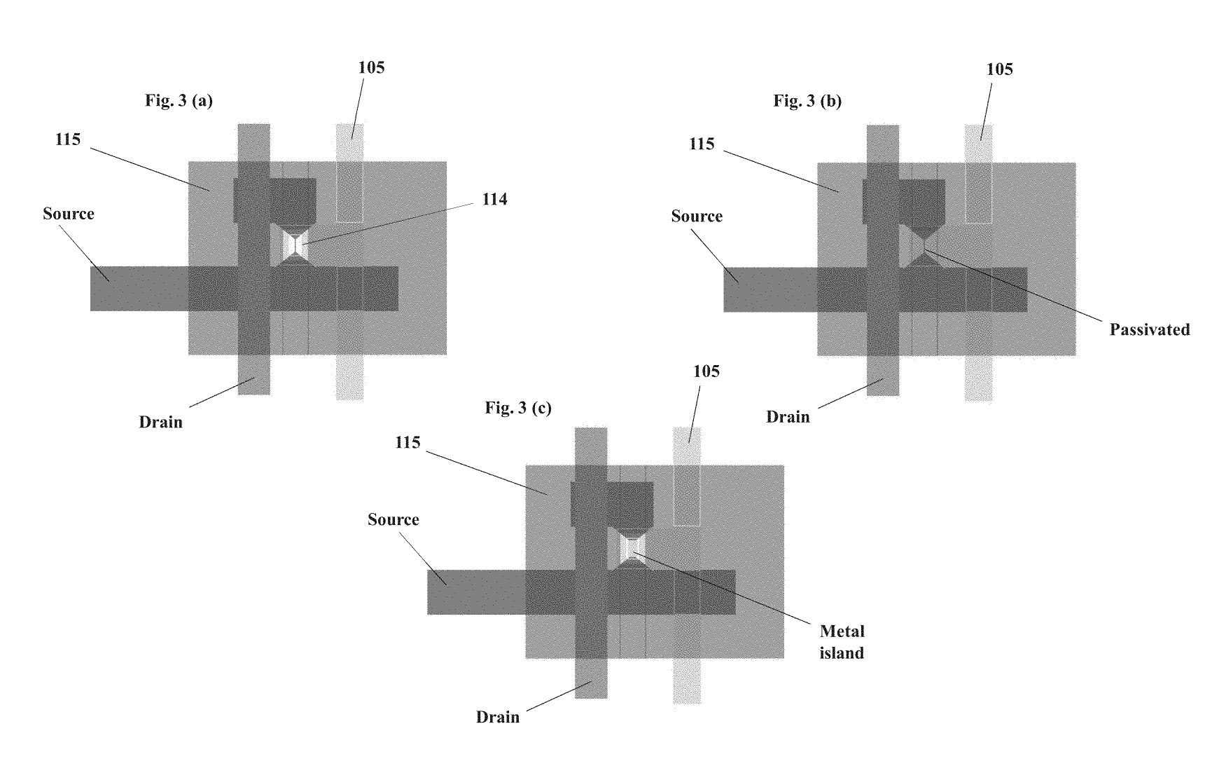

In general, the “open gate area” (106) of a sensing pixel is defined as an area between its source and drain contacts, which is directly exposed to a conductive medium, such as liquid or gas, capable of conducting electric current. This situation is schematically shown in FIG. 3(a).

The metal electrode (105) of the sensing pixel is not passivated since it should be in direct contact with the tested medium. Therefore, as mentioned above, there is an opening (114), which is made in the passivation layer (115), for leaving the sensing elements of the sensing pixel open to the medium, such as liquid or gas. An example of the conductive liquid is an electrolyte saline solution or buffer. In this case, instead of the fixed gate voltage, which is normally applied to a gate electrode, a reference potential is applied to the electrolyte-semiconductor system, via a reference electrode that is contacting the electrolyte. As a result, in the absence of the physical gate, the electrolyte itself becomes an open gate of the transistor.

In contrast to the sensing pixel, there is no open gate area in a compensating pixel, or to be more precise, the open gate area of the compensating pixel is completely passivated (the metal contact is now under the passivation layer), thereby creating a metal gate. This structure is similar to MOSFET, as illustrated in FIG. 3(b). That actually determines the type of a pixel in the inverting amplifier, i.e. makes it either sensing or compensating. There is a third case though, which is schematically shown in FIG. 3(c), when the gate area (106) can also be a metal layer contacting the silicon nanowire (101), but not the metal electrode (105), and hence, being exposed to the tested medium.

Depending on application purposes, the gate surface of a sensing pixel can be further modified by depositing other materials on the oxide layer, such as Si₃N₄, SiO₂ or similar listed above, for pH sensors, monolayer of polymer for biomolecular binding, or high-k materials to enhance the electronic coupling with biology systems. In a particular embodiment, the surface of the SiNW is coated with a metal, such as Au, Pt or Cu, or by a molecular passivation layer, to become pH-insensitive and serve as a reference element (in DC readout mode). It can also be used for a solution conductivity sensor (for pure ionic strength sensing), when used in AC readout mode.

The passivation process can be carried out by the method of atomic layer deposition (ALD) of the gate oxides, which are deposited directly on the SiNW surface. These gate oxides are excellent sensing interfaces due to high density of their active surface groups obtained in the surface activation process prior to surface functionalisation. The front gate voltage is applied through a reference electrode immersed in electrolyte solution on top of the gate oxide or by a surface engineered reference electrode on chip. Thus, the thick passivation layer on the contact leads is necessary for a reliable operation of the sensor in different electrolyte solutions as well as to avoid interfering with the signal at the gate oxide.

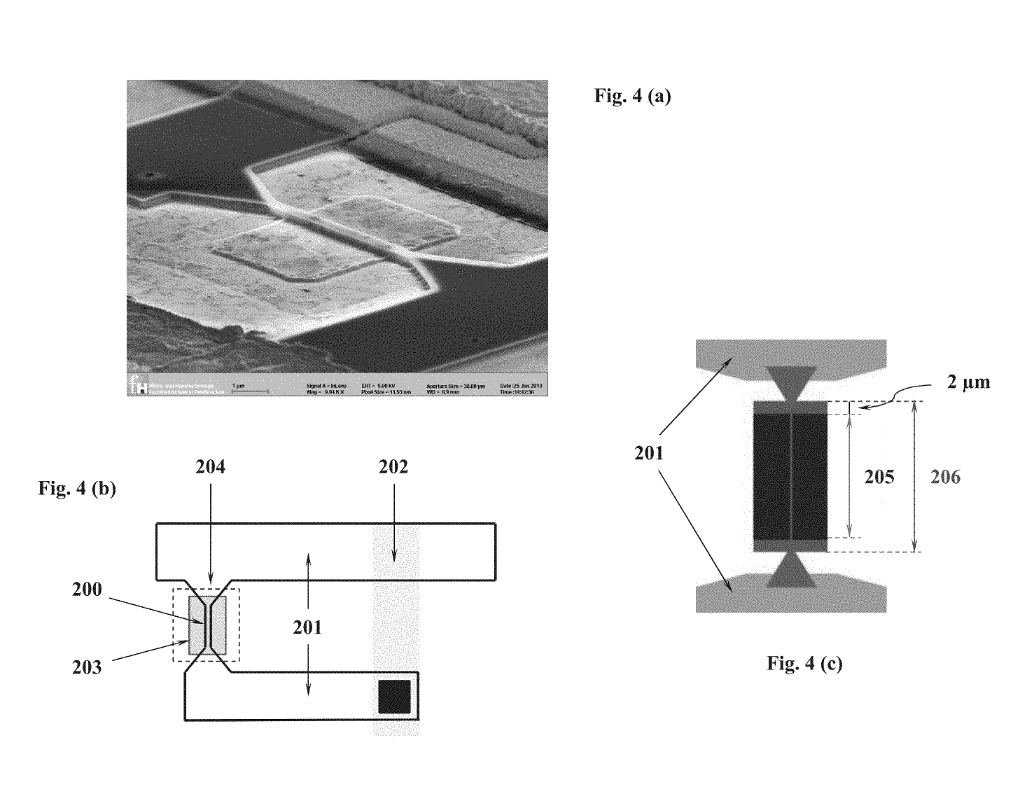

The SEM image of a single sensing pixel is shown in FIG. 4(a), while FIG. 4(b) schematically shows this sensing pixel. The SiNW (200) is grown between the implanted source and drain (201) using mask (203) to form self-aligned source and drain regions, and opening (204) for passivation. Metal feed line (202) connects the single channel with the array circuit. FIG. 4(c) schematically shows a SiNW of this pixel. The source and drain contacts (201) are highly ion-implanted. The non-implanted area (205) is shown in dark blue. The nanowire is the same lowly doped silicon as the original SOI wafer. The open gate area (206) is 2μm larger than the non-implanted area from each side of the nanowire.

In general, the low-doped SiNWs can be of n-type or p-type, or can be configured as tunnelling silicon nanowire devices (drain n-doped and source p-doped or drain p-doped and source n-doped). Therefore, the sensing pixel can be operated as either p-type transistor or n-type transistor depending on the applied voltages to the gate. The front-gate characteristics show that the SiNWs with non-implanted contact leads are n-channel transistors, while the SiNWs with highly boron doped contact leads are p-channel, enhancement-mode transistors. Generally, in contrast to back-gate operation, the electric signals of the front-gate operations are stable and reliable. A subthreshold slope of 90 mV/decade indicated that a high quality front-gate oxide can be achieved in the fabrication process, which can enhance sensitivity of the SiNWs devices.

For operating a single pixel, a front gate voltage (V_{GS}) is initially applied by a reference electrode (104), such as Ag/AgCl electrode, which is needed for the front gate contact to keep the electrochemical potential drop over the electrode-electrolyte interface stable (as a result, to keep the electrochemical potential of the solution stable) and the readout signal reliable. The reference electrode (104) actually is set to ground potential in the inverting amplifier of an embodiment and the source and drain potentials are applied at the respective contacts in the circuit.

When a sufficient bias potential is applied to the front gate with respect to the back gate of a sensing pixel, an electric current is immediately induced in the SiNW between the source and drain electrodes. The magnitude of the drain current is determined by an effective electrical resistance of the SiNW and the voltage applied between the source and drain electrodes (V_{DS}). The conductance of the SiNW between the source and drain is modulated by the voltage at the gate (reference electrode).

The SiNWs produced by the top-down process are usually treated as ISFETs of nano size. The sensing mechanism of these SiNW ISFETs is based on the accumulation of charged molecules near the SiNW surface, which leads to a surface potential shift. The transistor then responds to changes in the surface potential with a threshold voltage shift. While in MOSFETs, the metallic gate is in direct contact with the dielectric over the channel, in the ISFETs, the gate (reference) electrode is a distance away from the dielectric, with an intervening sample fluid. Changes at the dielectric-solution interface alter the surface potential, which acts as an additional gate voltage. The gate voltage V_{GS} is applied using a reference electrode to set the operating point of the device, and the conductance of the channel is measured by applying a drain-to-source voltage V_{DS}. Thus, the gate voltage actually modulates the current between the source and the drain.

### Inverting Amplifier

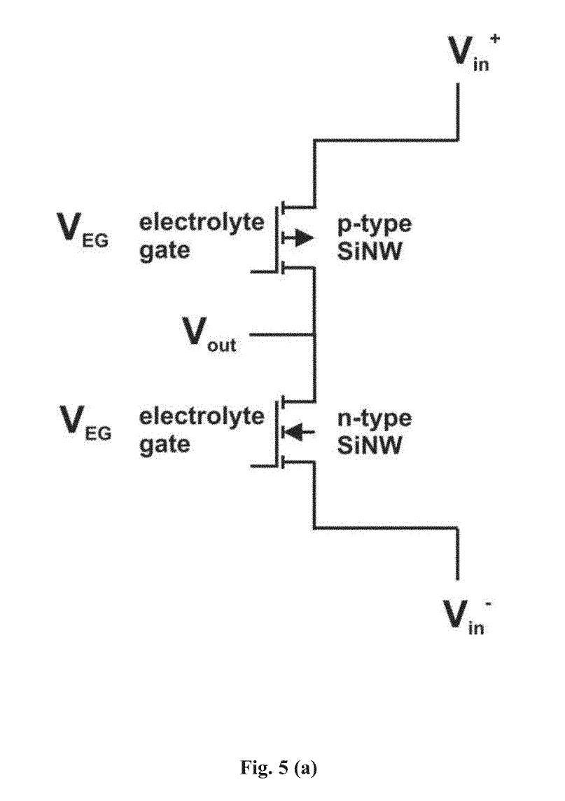

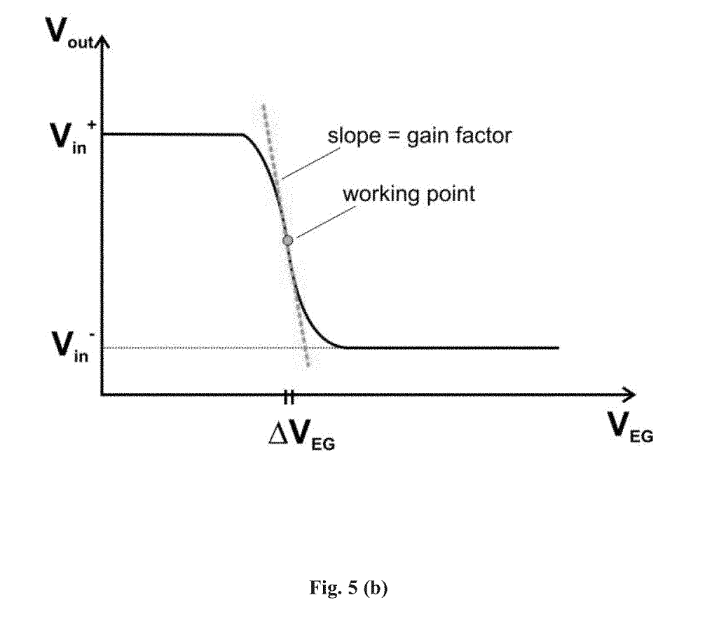

An inverting amplifier or inverter configuration is given by combination of an n-type and p-type transistor devices, as shown in FIG. 5(a), wherein the corresponding voltages in this figures are: Vᵢₙ⁺-positive input voltage; Vᵢₙ⁻-negative input voltage, which in most cases is set to ground; Vₒᵤₜ-output voltage of the inverting amplifier; and V_{EG}-electrolyte (open gate) voltage seen by both n-type and p-type SiNW transistors simultaneously. As mentioned above, the open gate voltage V_{EG} is set by a reference electrode, which is not shown in this circuit. The current flow in this inverting amplifier configuration is always delimited by the transistor with the lowest current (the highest channel resistance). Thus, when the above voltages are applied, the inverting amplifier of FIG. 5(a) shows the IA transfer behavior (follows the function), which is demonstrated in FIG. 5(b).

Depending on the device parameters, there is a transition of the output voltage Vₒᵤₜ of the circuit between the input voltage Vᵢₙ⁺ and The highest current flow is observed in the working point because the total resistance has the lowest value at this point. In general, in digital electronics, the slope of this transition can be very large leading to almost infinite amplification factors. In analogue electronics, however, using this configuration as a voltage amplifier is not that useful, since the working point in the center of the transition is very difficult to control.

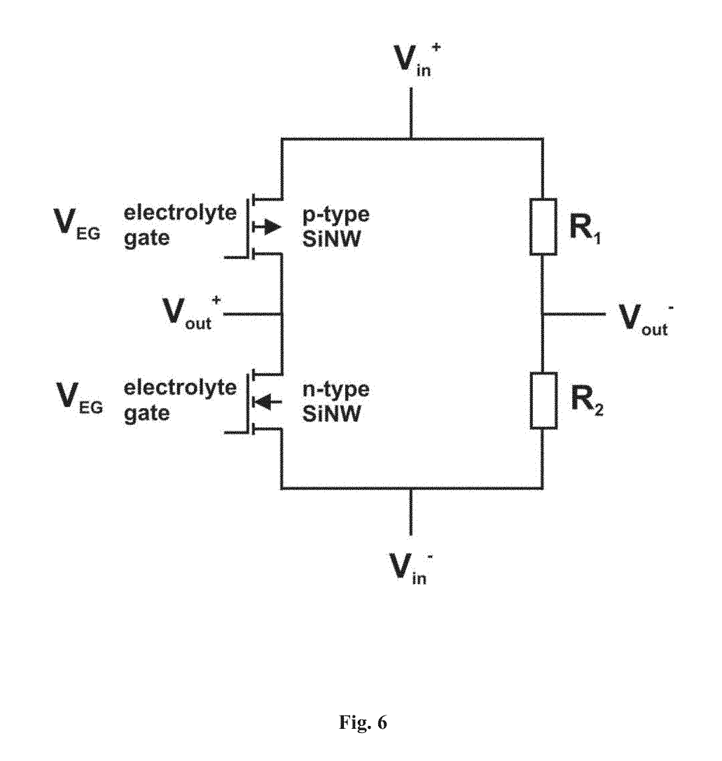

When using the amplifier function, one should apply the corresponding voltages such that the working point would be set to the point of the maximum slope. When analyte molecules become bound to both the n-type an p-type SiNW pixels (see FIG. 2), there will be a small potential shift ΔV_{EG} taking place at their solid-liquid interface. The potential shift ΔV_{EG} is then converted by the inverting amplifier into a ΔVₒᵤₜ with a gain factor defined by the slope of the transition. This gain factor can be compensated by using a second arm of the amplifier leading to a bridge configuration shown in FIG. 6. The second arm comprises two resistors R₁ and R₂ with a high value of resistance. Alternatively, for additional control and adjustment of this bridge, the positive output Vᵢₙ⁺ may be placed in the left arm, while Vᵢₙ⁻ may be placed in the right arm; both therefore become accessible independently.

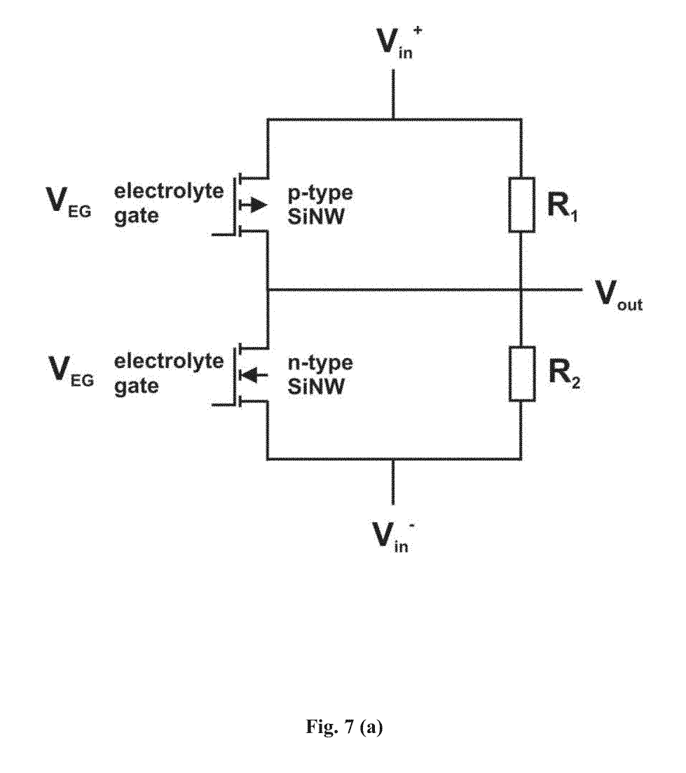

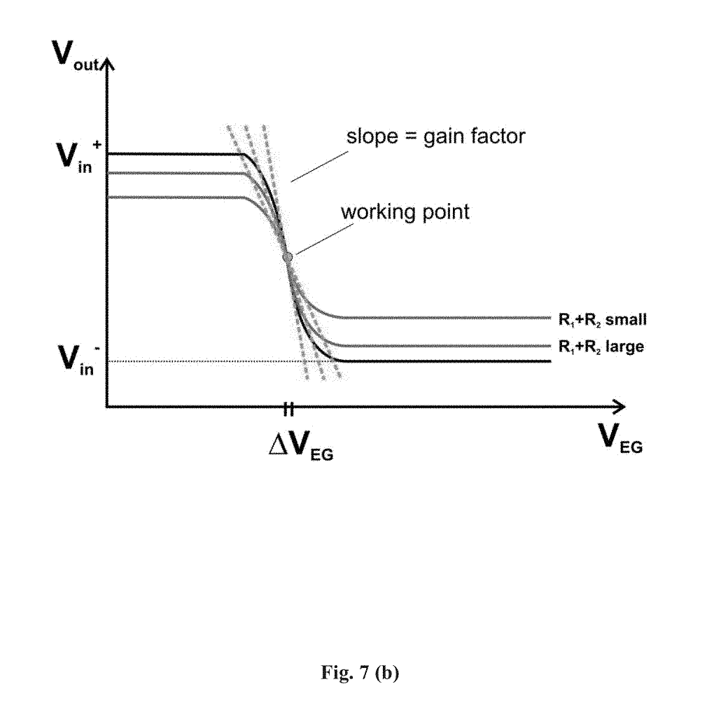

As shown in FIG. 7(a), a voltage divider may be used to shortcut two contacts to one voltage Vₒᵤₜ, which is measured against Vᵢₙ⁻. The slope of such configuration will then vary as shown in FIG. 7(b), which illustrates how the right arm influences the slope of the transition and consequently changes the gain of the inverting amplifier. In a static mode, the slope is decreased when using smaller resistors R₁ and R₂, but also the dynamic range of the sensor configuration (defined by the quasi-linear region in the transition) is limited. The voltage divider makes it possible to change the voltage transfer curve by its total resistance. This voltage divider will later be realized by two compensating pixels in the inverting amplifier circuit of the disclosure, which give the possibility to easily calibrate the inverting amplifier and to adjust the slope according to the application.

When transistors are used as variable resistors instead of resistors R₁ and R₂ in the second arm, the bridge can be used to dynamically adjust the gain. In some embodiments described in the present application, such bridge configuration can be realized by SiNW-based pixels only, wherein two pixels are exposed to a medium and used for sensing and two other pixels are completely metallized and passivated from the medium and used for gain adjustment or compensation as variable resistors.

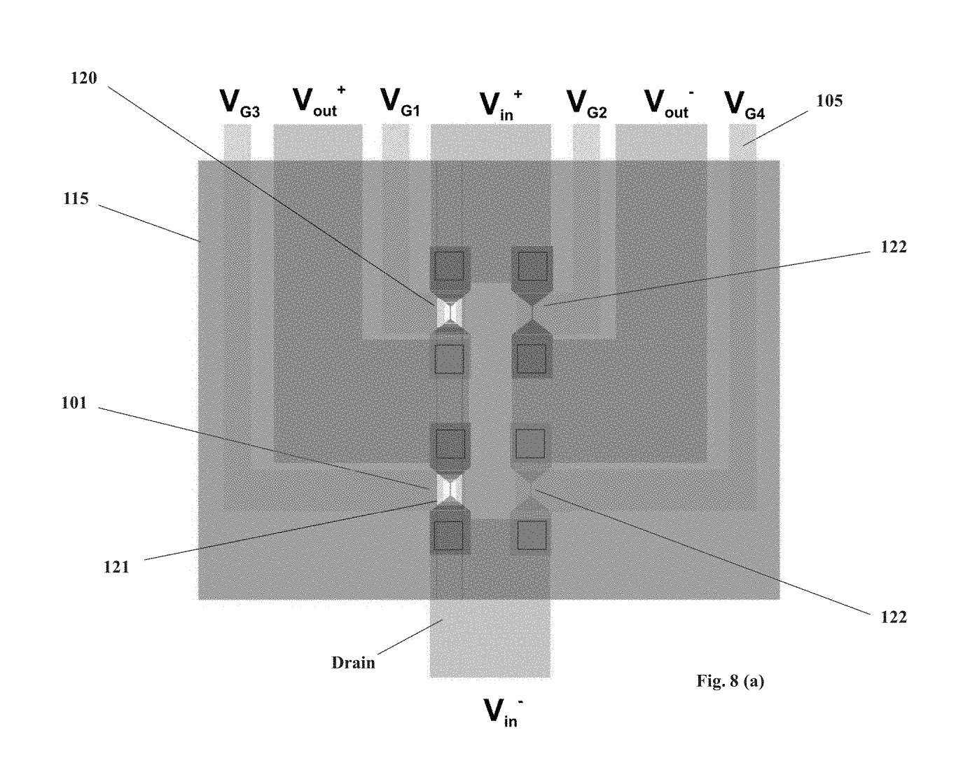

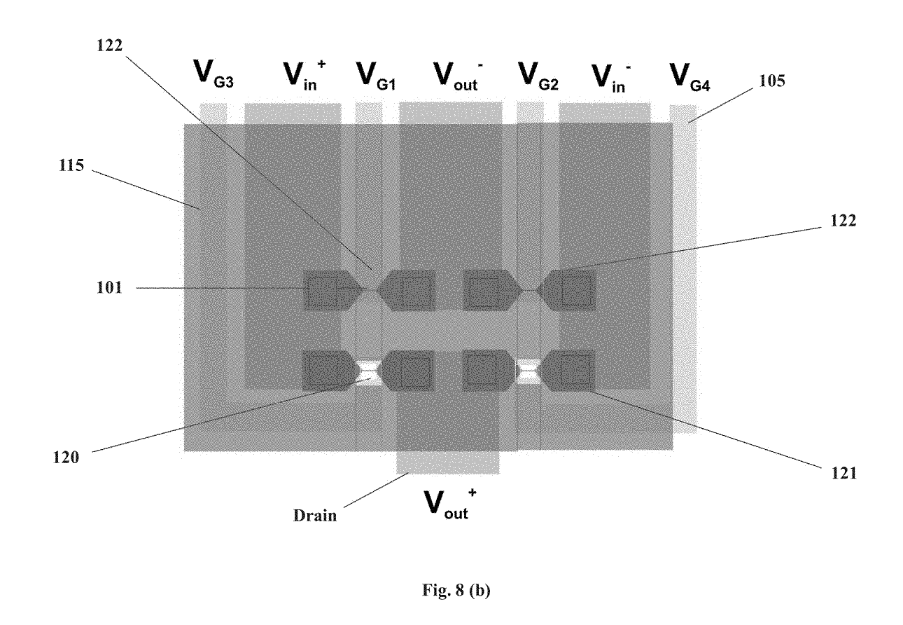

FIGS. 8(a)-(b) show a vertical and a horizontal mask design, respectively, of the inverting amplifier of an embodiment including four pixels (two sensing and two compensating), a metal electrode (105), such as gold, platinum or copper electrode, feeding each pixel with the high-frequency AC signal, and drain contact lead (preferably, aluminium or salicide).

The sensing pixels contain a p-type SiNW (120) and n-type SiNW (121) exposed to a tested medium and acting as electrolyte gates. The compensating pixels contain either p- or n-type SiNWs (122) completely metallised and coated with the passivation layer (115), thereby acting as metal gates of the transistor. In general, the SiNWs (101) are intrinsically doped. As mentioned above, each pixel is passivated with a passivation layer (115) only leaving the gate area of two sensing pixels open for sensing. As above, the reference electrode (not shown here) is placed outside of the inverting amplifier.

The pixels may be fabricated in a CMOS process with pre-processing and post-processing steps using a complete SOI CMOS process, where the top silicon layer is used as an active CMOS layer. In that case, the only post-processing is needed for the metal electrode, the reference electrode and the passivation layer. Alternatively, the pixels can be fabricated using a standard CMOS process. In that case, the pre-processing is needed to define the silicon nanowire from an SOI wafer covering it by Si₃N₄ and then etching the rest of the surface down to the handle wafer. Then such a wafer can be used in a standard CMOS process leaving the protected SiNW areas untouched. This process is then followed by the post-processing for the metal electrode, the reference electrode and the passivation layer.

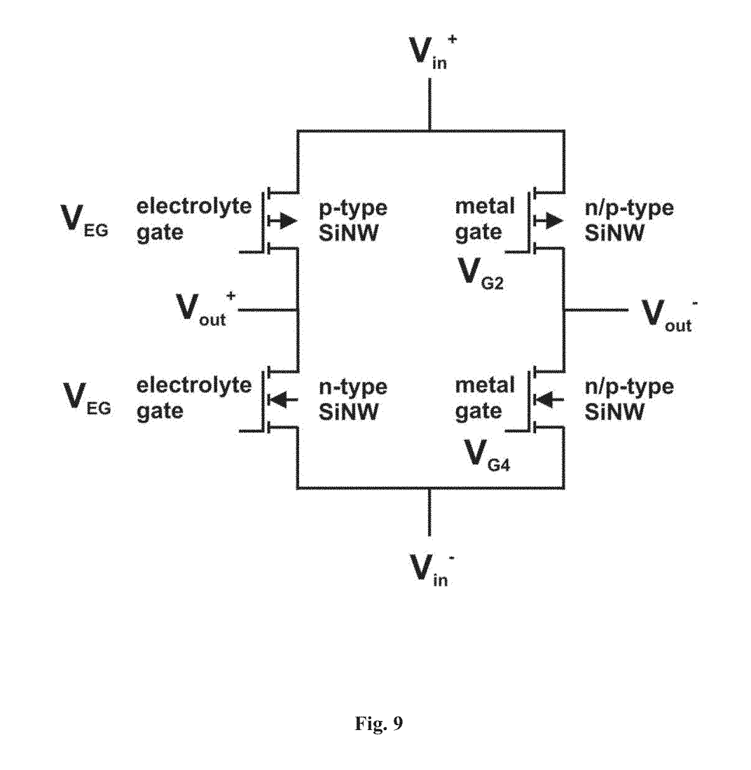

As mentioned above, sensing pixels are the pair of n-type and p-type SiNW based pixels, which are exposed to the electrolyte solution for sensing. When molecules are bound to their surface, the surface effect ΔVₒᵤₜ is translated into an output voltage change. The advantage of the inverting amplifier of some embodiments of the present invention is that no additional amplifier, such as an operational amplifier, is needed. This decreases the complexity of the readout amplifier board tremendously. The gain of each sensor element can be adjusted by compensating resistor pixels. Eventual variations from the process can be cancelled out by adjusting the slope of the individual pixels. FIG. 9 shows the inverting amplifier circuit of an embodiment with an adjustable gain. The metallized SiNWs of the compensating pixels used in the right arm can be either of n-type or p-type, independently. As mentioned above, both of them are operated in a subthreshold mode as variable resistors with high resistance.

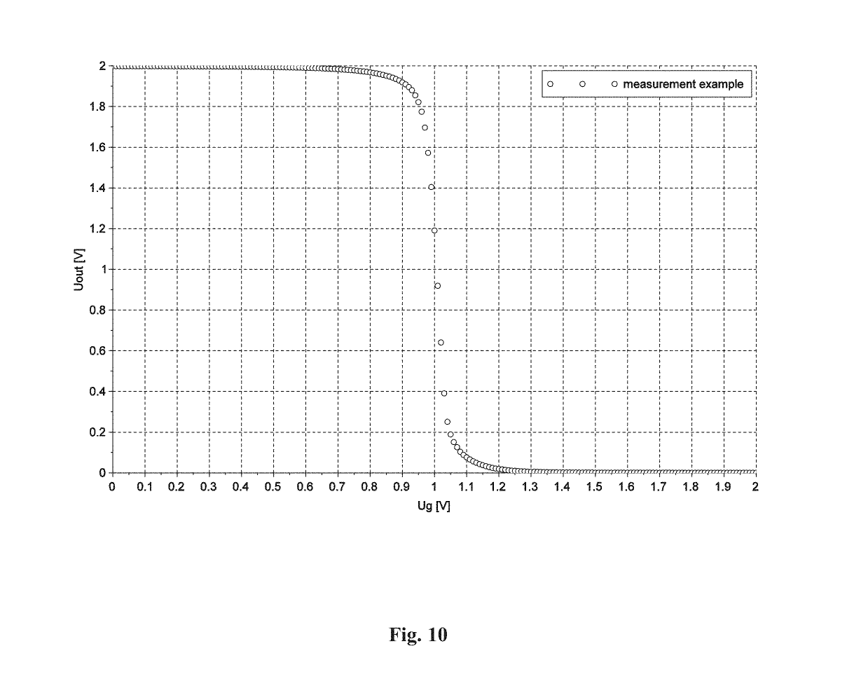

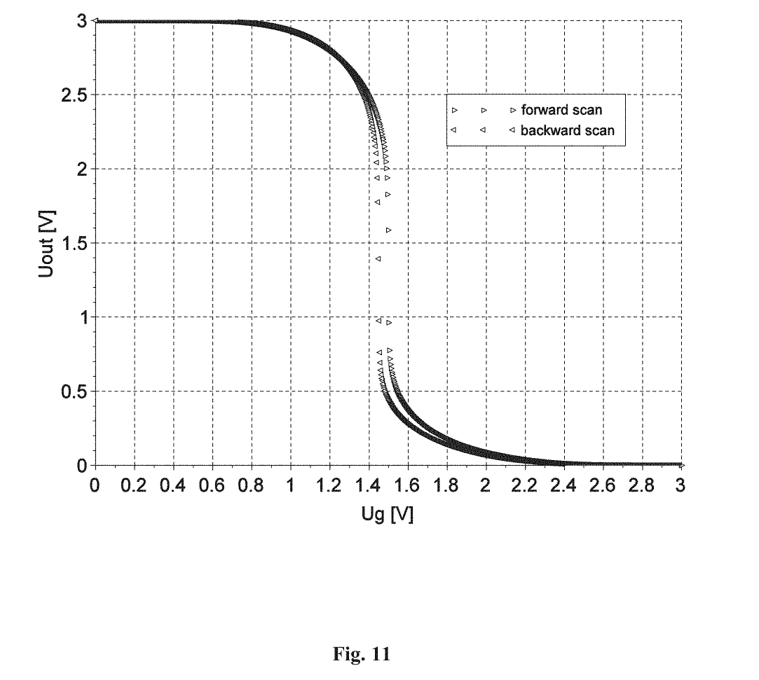

In general, since inverting amplifiers are designed to provide differential gain and good rejection of common-mode signals, they are very popular for sensors, such as strain gauges. FIG. 10 shows an IA transfer curve (voltage transfer characteristics) recorded with the inverting amplifier of the disclosure. It proves that the inverting amplifier circuit of the disclosure is working and that it has a huge slope i.e. gain factor. However, as seen in FIG. 11 showing the forward and backward scan with the inverting amplifier, there is also a small hysteresis originated from the fact that in the regular inverting amplifier, the working point is not controllable. The reason for that is probably high ionic strength, which makes it very difficult to find the working point. Using different delay times did not help to solve the problem of hysteresis. As seen in FIG. 11, the working point is around 1.5875V.

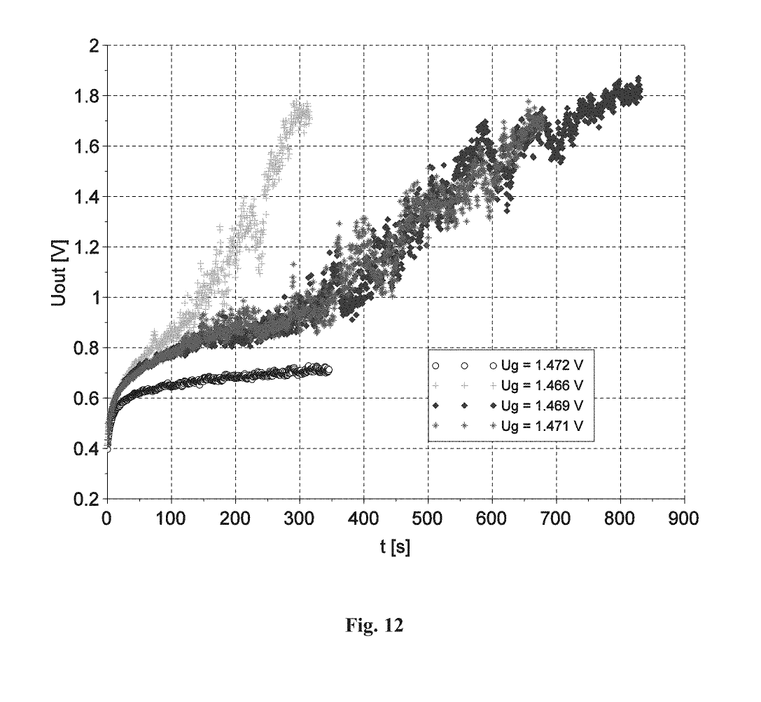

Many measurements have shown a slope in the IA transfer curve, which is so high that it was impossible to get the working point. For example, FIG. 12 shows a voltage drift measured over time. There are only 6 mV differences observed at the V_{EG} input, while a typical signal recorded for DNA hybridization in biosensing is 10-50 mV change in the V_{EG} voltage. It is clearly seen in this experiment that 1 mV input voltage alteration produces a huge output change. In addition, the output seems to be very unstable over time significantly changing the output behavior. Thus, in order to eliminate fabrication errors, e.g. deviations from outside to inside of the inverting amplifier, the slope should be tuned. Another reason is that a tunable slope makes it possible to adjust one and the same sensor chip based on the inverting amplifier of the disclosure to different applications. This is clearly a trade-off between sensitivity and range of the sensor.

Some embodiments of the present invention use the metallized SiNW-based pixels in the second arm to control the working point of the inverting amplifier and to adjust the gain factor. Such configuration allows compensating undesired effects, such as the voltage thermal drift. In the inverting amplifier configuration of the disclosure, shown in FIG. 9, the inverter is actually duplicated in parallel, and the voltage difference between the both is read out. This will result in that the temperature changes affect both voltages in the same way, but the desired sensing mechanism is only applied to one of them.

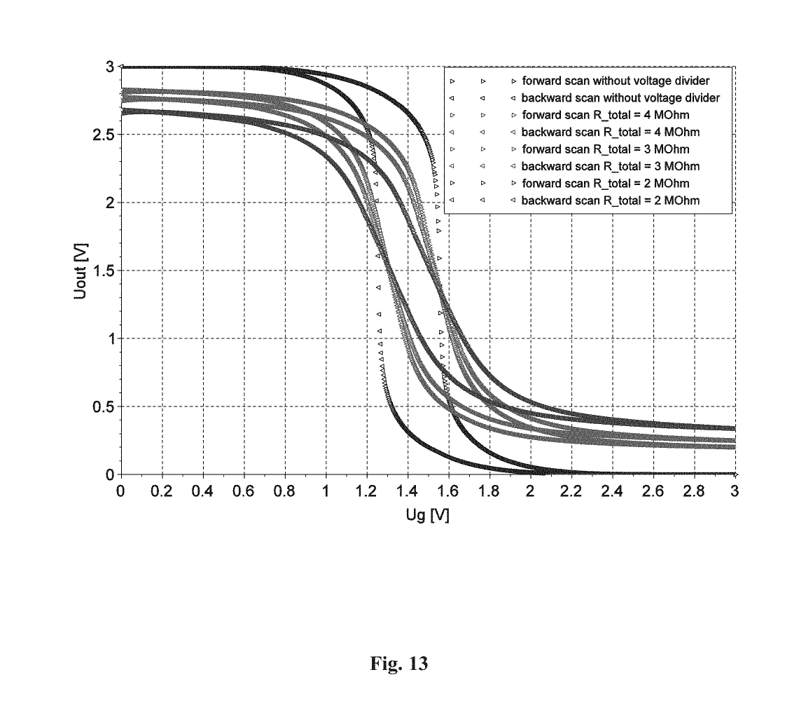

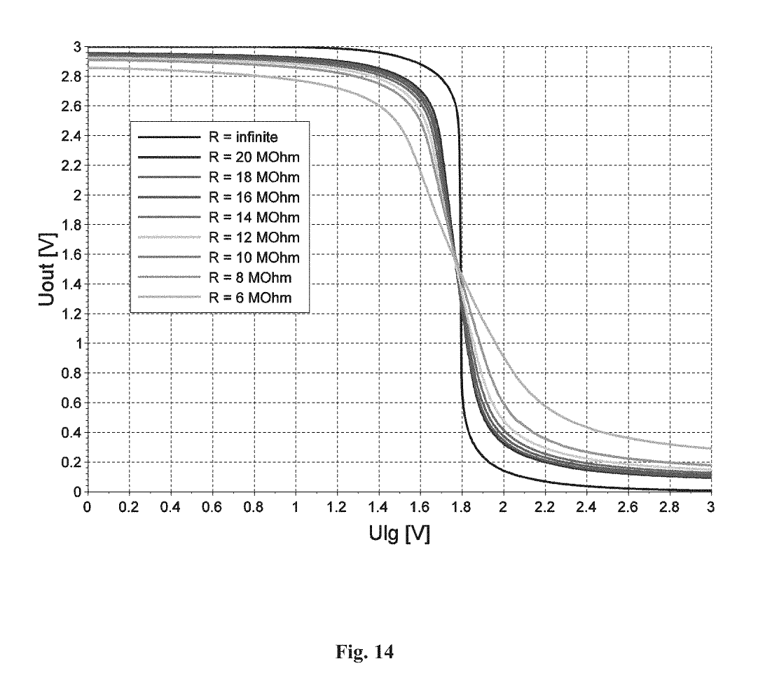

FIG. 13 shows the IA transfer curve for the inverting amplifier of the disclosure without the voltage divider and with the voltage divider at different total resistance values (2, 3 or 4 MΩ). Although, the hysteresis is still present, the slope is clearly changing as predicted. Now, in order to adjust the gain and working point, two compensating pixels are used in the second arm. In order to preserve the identical gain factor for all pixel-based inverting amplifiers connected in a sensor array, the additional gate electrodes at the sensing pixels, e.g. V_{G1} and V_{G3} in FIG. 8(a), may be used to apply a known test pulse and adjust the readout amplifier. By doing so the pixel-based inverting amplifiers sensor array would be totally independent from electronic variations coming from the process. The whole array may therefore be internally calibrated in a purely electronic procedure. The resulting shifts would then be only dependent on the surface reactions of the two sensing pixels. Thus, the voltage divider in parallel reduces the IA transfer function slope and therefore, increases the range, the lower the total resistance. The slope and consequently, the range can be adjusted by the total resistance of the voltage divider. FIG. 14 shows the IA transfer curve for the total resistance forward scan of the inverting amplifier of an embodiment at different total resistance values.

In another aspect of the disclosure, the sensing pixels' SiNWs are functionalised with different molecules (herein, “receptors”), which are capable of binding to a target (analyte) molecule, for sensing. As explained above, the second arm of the inverting amplifier is used only to adjust the slope in the IA transfer curve which gives the relation between Vₒᵤₜ and the ΔV_{EG}, the shift caused by biomolecules. The biomolecules need to be deposited on both p- and n-type sensing pixels in the same concentration and configuration. This gives the largest effect. As a result, the sensor of an embodiment based on the adjustable inverting amplifier can be used for label-free detection of target (analyte) molecules by monitoring changes in the voltage caused by variations in the charge density at the gate oxide-electrolyte interface.

While certain features of the present application have been illustrated and described herein, many modifications, substitutions, changes, and equivalents will be apparent to those of ordinary skill in the art. It is, therefore, to be understood that the appended claims are intended to cover all such modifications and changes as fall within the true spirit of the present application.

1. An inverting amplifier comprising:
two sensing pixels, each comprising:
a silicon nanowire exposed to liquid or gas medium for sensing; wherein said silicon nanowire of one pixel is of n-type and of another pixel is of p-type;
a metal electrode partially open for contact with said medium and used for feeding a high-frequency sinusoidal stimulation in impedance measurements and for sensing properties of said medium;
implanted source and drain electrodes connected to said silicon nanowire, leaving a gate area and parts of said metal electrode open for contact with said medium; and
electrical metal contacts attached to said implanted source and drain electrodes and connecting said pixel to an electrical circuit; and
two compensation pixels, each comprising:
an n-type or p-type silicon nanowire directly contacted with a metal electrode placed on top of said silicon nanowire;
said metal electrode coated with a passivation layer providing isolation from said medium;
implanted source and drain electrodes connected to said silicon nanowire, and
electrical metal contacts attached to said implanted source and drain electrodes and connecting said pixel to an electrical circuit,
wherein the two compensation pixels are configured as adjustable resistors for adjusting amplification factor to operate all the pixels of said inverting amplifier at the same amplification factor, and cancelling out variations from processing.

2. The inverting amplifier of claim 1 further comprising a reference electrode.

3. The inverting amplifier of claim 1, wherein said silicon nanowires are low-doped p-type, low-doped n-type, drain n-doped and source p-doped, or drain p-doped and source n-doped.

4. The inverting amplifier of claim 1, wherein said metal electrode is a noble metal counter electrode.

5. The inverting amplifier of claim 4, wherein said noble metal is platinum, gold or copper.

6. The inverting amplifier of claim 2, wherein said reference electrode is an Ag/AgCl reference-cell electrode.

7. The inverting amplifier of claim 1, wherein said metal electrode of said sensing pixels is not passivated and in direct contact with said medium.

8. The inverting amplifier of claim 1, wherein the surface of said silicon nanowire of said sensing pixels is coated with pH-sensitive oxide or nitride dielectric for use as a pH-reference element.

9. The inverting amplifier of claim 8, where said pH-sensitive oxide or nitride dielectric is made of SiO₂, Al₂O₃, Ta₂O₅, HfO₂, TiO₂, ZrO₂, TiN or Si₃N₄.

10. The inverting amplifier of claim 9, where said pH-sensitive oxide dielectric is made of Al₂O₃ or Ta₂O₅.

11. The inverting amplifier of claim 1, wherein the surface of said silicon nanowires of said sensing pixels is coated with either a metal- or a molecular-passivation layer for negating the pH-sensitivity of said surface and consequently using the sensor as a solution conductivity reference element for pure ionic strength sensing.

12. The inverting amplifier of claim 11, where said metal-passivation layer is made of Au, Pt, Al, Wo, or Cu.

13. The inverting amplifier of claim 1, wherein said sensing pixels further comprise a back gate at the bottom for tuning a threshold voltage.

14. The inverting amplifier of claim 1, wherein the surface of said silicon nanowires of said sensing pixels is functionalised with receptor (capture) molecules capable of binding to target (analyte) molecules.

15. A method of using the inverting amplifier of claim 1 for label-free detection of a target molecule (analyte) in a medium by monitoring changes in an electric current recorded by a sensor open for contact with said medium.
